(19) United States
(12) Patent Application Publication
(10) Pub. No.: US 2018/0311878 A1
(43) Pub. Date: Nov. 1, 2018

(54) PLASTIC INJECTION-MOULDING MACHINE HAVING A DATA MEMORY FOR STORING TEXT INFORMATION AND/OR IMAGE INFORMATION

(71) Applicant: KraussMaffei Technologies GmbH, 80997 München (DE)

(72) Inventor: Günther Grimm, 86567 Hilgertshausen (DE)

(73) Assignee: KraussMaffei Technologies GmbH, 80997 München (DE)

(21) Appl. No.: 15/769,688

(22) PCT Filed: Aug. 5, 2016
(86) PCT No.: PCT/EP2016/068800

§ 371 Date: Apr. 19, 2018

(30) Foreign Application Priority Data
Oct. 30, 2015 (DE) 10 2015 118 570.9

(51) Int. Cl. B29C 45/76; G05B 19/4155

(52) U.S. Cl. CPC B29C 45/762; B29C 45/766; B29C 45/768; G05B 2219/45204; B29C 2045/7606; B29C 2945/76464; B29C 2945/76939; G05B 19/4155

(57) ABSTRACT

A plastic injection-moulding machine includes an injection unit for processing a plastic mass, and a closing unit having an injection-moulding tool with a cavity, into which plastic mass is injected by the injection unit to produce a moulded part. A machine controller controls the injection unit and the closing unit according to a machine program running on the machine controller. A user interface device communicates with the machine controller and has a screen for displaying text information and/or image information. The machine controller includes a data memory for storing the text information and/or image information in the form of data sets, and a process generator for manually assigning each state parameter of the plastic injection-moulding machine a data set. The process generator automatically writes the data set into the data memory or automatically reads out the data set for display on the screen in accordance with the associated state parameter.

The invention relates to a plastic injection-moulding machine, comprising an injection unit for processing a plastic mass to be moulded, a closing unit having at least one injection-moulding tool, which has at least one cavity, into which the plastic mass processed by the injection unit is injected in order to produce a moulded part, and comprising a machine controller, which is designed to control the injection unit and the closing unit in accordance with a machine program running on the machine controller, and a user interface device, which communicates with the machine controller and which has at least one screen for displaying image information.

From WO 2007/028721 A1 an injection-moulding installation is known, having an injection-moulding machine comprising an injection unit and a closing unit with injection-moulding tools for the production of moulded parts, and a screen, and with a working space comprising the injection-moulding machine itself and, if applicable, auxiliary equipment, in which one or more cameras are provided for monitoring the working space, wherein the images of the various cameras are able to be presented selectively in succession and/or simultaneously on the screen. The images of the cameras can be recorded over a specifiable period of time.

US 2004/0088073 A1 describes a human-machine interface which has an input unit, via which text information can be captured as electronic data, and a memory in which the text information inputted via the input unit is stored as electronic data. In addition, the human-machine interface comprises here a command unit for display of the text information and a display control unit, which is designed to display the text information and namely on a display according to the commands of the command unit.

WO 2006/089451 A1 describes a method for controlling and operating a production cell for the production of plastic injection-moulded parts with at least one portion of the auxiliary equipment associated with it, wherein the production sequence is predetermined and parameterized by the user, and machine sequences are prepared, managed and executed on the basis of behaviourally complete components, which together form a domain model, by means of a domain language, in order to enable the use and operation of an injection-moulding machine in a manner which can be learned simply and is universal.

AT 513666 A1 describes an operating unit for an injection-moulding machine having a screen, a data processing device and at least one manual button for operating injection-moulding machine elements, wherein information available in the injection-moulding machine, belonging to injection-moulding elements, is able to be retrieved by the data processing device.

DE 10 2006 017 499 A1 describes a control device for use in an injection-moulding machine, which has a temperature control section which controls the temperatures of parts of the cylinder to predetermined values by controlling the heating arrangements; which has a displacement minus temperature adjustment means memory, which adjusts a displacement minus temperature to uniformly below the control temperatures of the parts; which has a displacement absolute temperature adjustment means memory, which adjusts a displacement absolute temperature below the control temperatures of the parts to a predetermined temperature; and which has a selection means, which selects the temperatures adjusted in the temperature adjustment means memories to below the temperature of the parts, controlled by the temperature control section.

It is an object of the invention to provide a plastic injection-moulding machine in which machine states and/or events at the plastic injection-moulding machine can be conveyed particularly clearly to a machine operator.

The problem is solved by a plastic injection-moulding machine, having an injection unit for processing a plastic mass which is to be moulded, a closing unit with at least one injection-moulding tool, which has at least one cavity, into which the plastic mass processed by the injection unit is injected, in order to produce a moulded part, and having a machine controller, which is designed to control the injection unit and the closing unit in accordance with a machine program running on the machine controller, and a user interface device communicating with the machine controller, which user interface device has at least one screen for presenting image information, wherein the machine controller has a data memory for storing the text information and/or image information in the form of a plurality of data sets, and the machine controller has a process generator, which is designed to manually assign each state parameter of the plastic injection-moulding machine a data set, and the process generator is also designed to automatically write the corresponding data set into the data memory or to automatically read out the corresponding data set for display on the screen in accordance with the associated state parameter, wherein the process generator is able to be operated in a programming mode for manual assignment respectively of a data set to a state parameter of the plastic injection-moulding machine, and is able to be operated in a process mode in which the respective data set is automatically written into the data memory or is automatically read out for display on the screen in accordance with the associated state parameter.

A manual assignment can take place in that the user interface device has at least one input means, which is designed to assign a selected state parameter to an activated data set on the basis of a manual input by a machine operator. Such an assignment can be stored in the form of a logical linking of the data set with the state parameter. Thus, a machine operator or respectively an operator of the plastic injection-moulding machine can specify, i.e. program, his own communication sequences independently of a factory-provided setting by the manufacturer of the plastic injection-moulding machine. Such communication sequences can be recorded and stored in the machine controller for subsequent retrieval and activated for subsequent automatic execution. In such communication sequences provision can be made, for example, that on the screen of the user interface device text or images in the form of individual images, in the form of image sequences or in the form of a video film are automatically displayed in accordance with a particular assigned machine state of the plastic injection-moulding machine. The user interface device can, in addition, have at least one input means which is designed for manual confirmation of a text displayed on the screen or of displayed images in the form of individual images, in the form of image sequences or in the form of a video film.

The process generator can be operable in a programming mode for the manual assignment respectively of a data set to a state parameter of the plastic injection-moulding machine, and operable in a process mode, in which the respective data set is automatically written into the data memory in accordance with the assigned state parameter or is automatically read out for display on the screen. Thus, for example, a camera can continuously capture a scene at the plastic injection-moulding machine and, in the case of a fault report which represents a state parameter of the plastic injection-moulding machine, can permanently store in the data memory the continuously captured scene, for example in the form of a video, and namely even for a period of time which already lies before the event which has triggered the malfunction and, consequently, the malfunction report. If no malfunction occurs, the scene captured by the camera is not stored permanently, but rather is discarded, and the data memory remains free.

The plastic injection-moulding machine can have at least one camera which is designed to capture images of the environment of the plastic injection-moulding machine in the form of image information, and the machine controller can be designed here to write or respectively record the image information in the data memory, and to read out the information again from the data memory and display it on the screen. The machine controller can be arranged to automatically display on the screen the image information stored in the data memory, in accordance with a state parameter of the plastic injection-moulding machine.

A plastic injection-moulding machine generally comprises at least one injection unit for processing a plastic mass which is to be moulded, an injection nozzle arranged at the front end of the injection unit, which injection nozzle is able to be coupled to an injection-moulding tool, the injection-moulding tool and a closing unit, which is usually arranged on a machine frame of the plastic injection-moulding machine, and has a fixed platen and a movable platen. The injection-moulding tool comprises at least two mould halves, one mould half of which is secured on the fixed platen and the other mould half of which is secured on the movable platen, such that with an opening of the closing unit, i.e. with a moving apart of the fixed platen and the movable platen, the at least one cavity of the injection-moulding tool is freed. The injection unit can have one or more extruders which are respectively designed to melt, mix and homogenize, if applicable de-gas, at least one plastic pre-product, such as a plastic granulate for example. Each extruder can, in addition have a charging hopper for the feeding of, for example, a plastic granulate.

The plastic injection-moulding machine has a plurality of machine parts. Certain machine parts can be mounted so as to be movable and can be moved automatically by means of a motor or drive, in particular a hydraulic or electric motor or respectively a hydraulic or electric drive, or can be moved in a manually controlled manner in a manual driving operation. Thus, the closing unit represents an exemplary machine part which, controlled by the machine controller of the plastic injection-moulding machine, in accordance with a machine program running in the machine controller, can be opened or closed automatically, or in a manual driving operation for example by means of the user interface device, in a manually controlled manner. The injection unit which, controlled by the machine controller of the plastic injection-moulding machine according to a machine program running in the machine controller, can be operated automatically or in a manually controlled manner in manual driving operation for example by means of the user interface device for example by controlling or regulating the rotation speed of a screw conveyor of the injection unit or by controlling or regulating at least one heating device of the injection unit, represents another exemplary machine part.

The user interface device can have at least one input means and at least one output means. At least one output means can be designed as a screen. The user interface device can, apart from a small number of safety-relevant electromechanical input means, such as for example an emergency stop switch, be formed substantially solely by a single screen. The screen can be designed as a touchscreen and in this respect can have both output means and also input means. The user interface device can have a housing which comprises a front side and a rear side, wherein the screen is arranged on the front side.

By the machine controller having a data memory for the storing of image information of the recorded images, and by the machine controller being arranged to automatically display on the screen the image information stored in the data memory in accordance with a state parameter of the plastic injection-moulding machine, machine states and/or events at the plastic injection-moulding machine can be conveyed to a machine operator particularly clearly. In the prior art, only individual images, i.e. static recordings, can be displayed at the manual request of the machine operator, where, on the other hand, with the solution according to the invention, images, but also image sequences, film sequences, video films and/or sound, or respectively also spoken text and music can be emitted, and namely triggered automatically by the machine controller in accordance with an event and/or of a machine state of the plastic injection-moulding machine.

The machine controller can be arranged to automatically record images from the region of the plastic injection-moulding machine in accordance with a state parameter of the plastic injection-moulding machine, and to deposit these as image information in the data memory.

The data memory can be configured for the storing of image information or of further multimedia information, and the machine controller can be arranged here to record, display, or deposit in the data memory the image information or respectively the further multimedia information, in accordance with a state parameter of the plastic injection-moulding machine.

The state parameter of the plastic injection-moulding machine can be a program command in a sequence of several program commands of the machine program.

Alternatively or additionally to a program command, the state parameter of the plastic injection-moulding machine can be a sensor signal, which is provided by a sensor of the plastic injection-moulding machine communicating with the machine controller, monitoring at least one process parameter of the plastic injection-moulding machine.

Alternatively or additionally to a program command or a sensor signal, the state parameter of the plastic injection-moulding machine can be a control signal representing a malfunction at the plastic injection-moulding machine.

The machine controller can be designed to automatically display images, associated with a respective malfunction type, in the form of individual images, in the form of image sequences or respectively film sequences or in the form of a video film on the screen of the user interface device, when the control signal conveyed to the machine controller contains information characterizing the malfunction type.

The machine controller can generally be designed here for manual inputting and for storing and outputting of indicated text information and/or image information at the plastic injection-moulding machine, and the image information stored in the data memory can be assigned here to a respective item of text information and/or image information.

A graphic and/or text-oriented programming environment present at the plastic injection-moulding machine can be expanded thereby by a freely programmable application. The freely programmable application can contain here program commands for multimedia components. The freely programmable application can accordingly contain program commands for the recording of sound, image and/or film- or respectively video sequences. Such a recording can take place for documentation purposes. Such a recording can record events at the plastic injection-moulding machine and, for example, also capture and record sensor signals.

Thereby, the machine operator or respectively a user of the freely programmable application at the plastic injection-moulding machine can react to particular events and/or states in the machine programming and start an automated recording or respectively also stop it again. With the recorded image information or respectively the recorded sound, image and/or film- or respectively video sequences, on the one hand for example events can be documented or for example a recording during a particular maloperation or respectively fault of the plastic injection-moulding machine can be viewed at a later point in time, for example in order to be able to analyse the maloperation or respectively the fault.

However, instructions in a specified manner, recorded in the form of sound, image and/or film- or respectively video sequences can also be deposited in the data memory and can be automatically displayed on the screen and namely in accordance with the type of maloperation or respectively fault of the plastic injection-moulding machine. Thus, it can be automatically displayed or respectively played to the machine operator which steps are to be taken, for example which manoeuvres the machine operator is to be carry out manually, in order to rectify the maloperation or respectively the fault. Thereby, the machine operator can react to particular events or respectively states at the plastic injection-moulding machine and namely in accordance with the permanently stored or respectively programmed instructions, which then show on the screen of the user interface device how the machine operator is to act in the respective case. In addition, the machine controller can be arranged to acknowledge an action of the machine operator and to only permit the further automatic running of a machine program when the machine operator has actually acknowledged. Thus, provision can be made that, in the case where for example a machine safety device responds, the machine operator is required to manually check all moulding posts, i.e. cavities, by means of a testing device, in order to establish that no material residues have remained in the moulding posts, which can be recorded, and after which a renewed starting-up of the plastic injection-moulding machine only takes place when the recording has been stored or respectively the machine operator has acknowledged the carrying out of the request.

The user interface device can have at least one input means and the machine controller can be arranged, in the case of a manual actuation of the at least one input means, to record the images and to deposit them as image information in the data memory.

The machine controller can be designed to record the images in the form of individual images, in the form of image sequences or in the form of a video film, and to deposit them on the data memory.

An exemplary case of application for the invention can be, for example, the production of safety components, in which before an injecting-around with plastic, a safety-relevant insert part is inserted into the injection mould, which after the injection process is at least partially or even completely injected around and therefore is no longer discernible. After a demoulding, the safety-relevant insert part can no longer be identified. By the process of inserting the safety-relevant insert part into the injection mould being recorded, and if applicable also documented, in particular indicated as belonging to the injection moulded part, the injection process can be retraced at any time. In this connection, the capturing of only one photo can already be sufficient, or an image sequence or a video film can be captured. Each safety-relevant insert part can also have an individual distinguishing mark, such as for example a numerical code, which is also registered by the recording and is stored on the data memory.

By means of additional program commands in the freely programmable application, other information, such as for example a date, a time or the current value of a piece counter of the plastic injection-moulding machine can be registered in the recording and stored on the data memory.

In addition, processes in the assembly of complex components or parts of the plastic injection-moulding machine can also be recorded during an installation, in particular as a video sequence. Such recordings can then also be stored, for example linked to the order, for the purposes of evidence. Generally, manual activities for example of the machine operator at the plastic injection-moulding machine can also be captured and stored on the data memory.

An exemplary example embodiment of the invention is explained in further detail in the following figure description with reference to the enclosed diagrammatic figures. Concrete features of this example embodiment can also, if applicable, represent, individually or regarded in other combinations, general features of the invention irrespective of the concrete context in which they are mentioned.

There are shown:

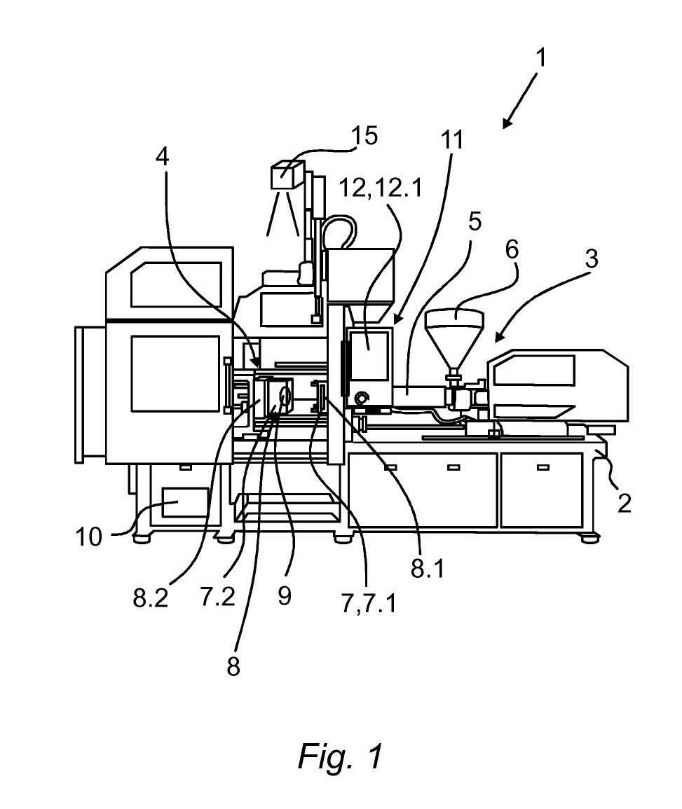

FIG. 1 a diagrammatic illustration of an exemplary first embodiment variant of a plastic injection-moulding machine with a user interface device,

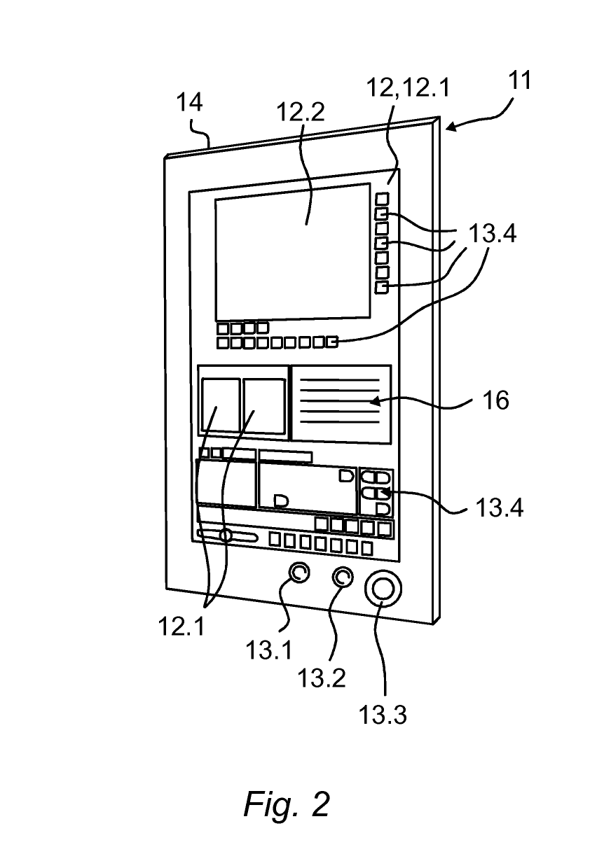

FIG. 2 a diagrammatic illustration of an exemplary embodiment variant of a user interface device, and

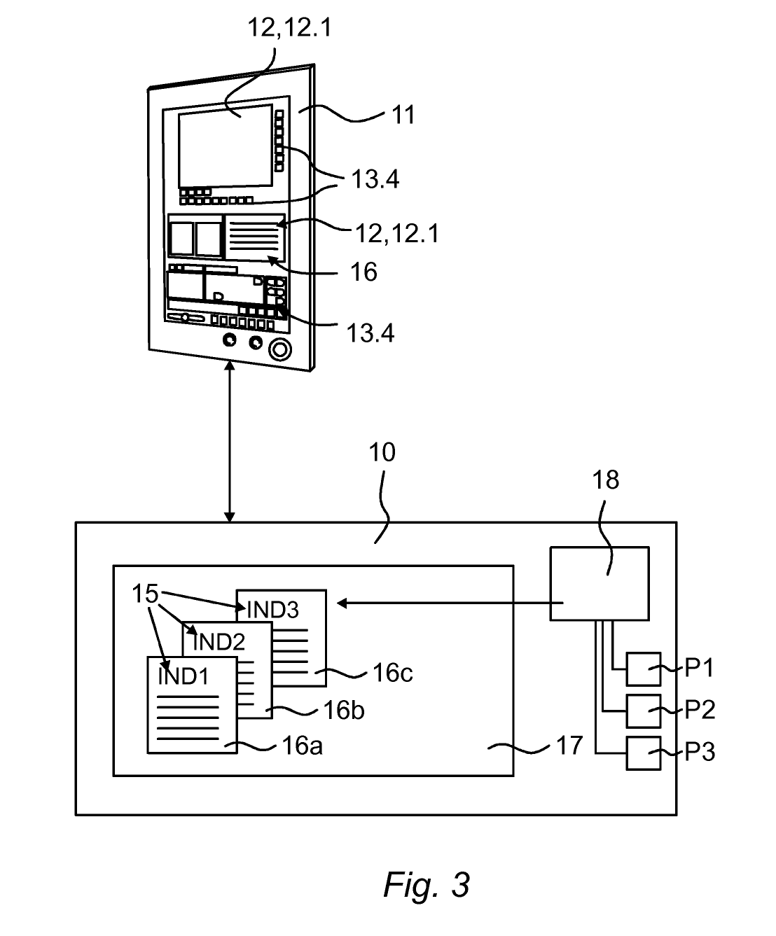

FIG. 3 a diagrammatic illustration of an exemplary machine controller.

The exemplary plastic injection-moulding machine 1 shown in FIG. 1 has a machine frame 2, on which an injection unit 3 and a closing unit 4 are arranged.

The injection unit 3 serves for processing a plastic mass which is to be moulded. In the case of the present example embodiment, the injection unit 3 has an extruder 5. The extruder 5 is designed to melt, mix and homogenize, if applicable degas, at least one plastic pre-product, such as for example a plastic granulate. For this, or respectively for the feeding of e.g. the plastic granulate, the extruder 5 has a charging hopper 6.

At a front end of the injection unit 3 or respectively at a front end of the extruder 5, an injection nozzle is arranged, which is not illustrated in further detail and which is coupled to an injection-moulding tool 7. The injection-moulding tool 7 is arranged in a closing unit 8 of the plastic injection-moulding machine 1, which is usually arranged on the machine frame 2 of the plastic injection-moulding machine 1 and has a fixed platen 8.1 and a movable platen 8.2. The injection-moulding tool 7 comprises at least two mould halves 7.1 and 7.2, of which the one mould half 7.1 is secured on the fixed platen 8.1 and the other mould half 7.2 is secured on the movable platen 8.2, such that on an opening of the closing unit 8, i.e. on a moving apart of the fixed platen 8.1 and movable platen 8.2 at least one cavity 9 of the injection-moulding tool 7 is freed.

The plastic injection-moulding machine 1 has accordingly a plurality of machine parts. Certain machine parts can be movably mounted and moved automatically by means of a motor or drive, in particular a hydraulic or electric motor or respectively hydraulic or electric drive, or moved in a manually controlled manner in a manual driving operation. Thus, the closing unit 4 represents an exemplary machine part which, controlled by a machine controller 10 of the plastic injection-moulding machine 1, in accordance with a machine program running in the machine controller 10, can: be opened or closed automatically or in a manually controlled manner in a manual driving operation for example by means of a user interface device 11 of the plastic injection-moulding machine 1. The injection unit 3 represents another exemplary machine part which, controlled by the machine controller 10 of the plastic injection-moulding machine 1, in accordance with a machine program running in the machine controller 10, can be operated automatically or in a manually controlled manner in a manual driving operation for example by means of the user interface device 11, for example by controlling or regulating the rotation speed of the extruder 5 or by controlling or regulating at least one heating device, not illustrated in further detail, of the injection unit 3.

The machine controller 10 is arranged to automatically record image information of the images, captured by the at least one camera 15 of the plastic injection-moulding machine 1, from the region of the plastic injection-moulding machine 1 and to deposit it in the data memory 17 in accordance with a state parameter of the plastic injection moulding machine 1.

As illustrated in particular in FIG. 2, the user interface device 11 communicating with the machine controller 10 in the case of the present example embodiment has a housing 14, a plurality of input means 13.1-13.4 and output means 12, wherein at least one output means 12 is designed as a screen 12.1. The machine controller 10 is designed here for the manual inputting and for the storing and outputting of indicated text information and/or image information 16 at the plastic injection-moulding machine 1, i.e. for the outputting at the output means 12 or respectively on the screen 12.1 of the user interface device 11, wherein the image information, stored in the data memory 17 (FIG. 3) is assigned to a respective indicated item of text information and/or image information 16, 16a, 16b, 16c.

Accordingly, the machine controller 10, as shown diagrammatically in FIG. 3, has the data memory 17 for the storing of image information or further multimedia information, wherein the machine controller 10 is arranged, in accordance with a state parameter of the plastic injection-moulding machine 1, to record, indicate or deposit in the data memory 17 the image information or respectively the further multimedia information.

The machine controller 10 has the data memory 17 for storing the text information and/or image information in the form of several data sets, and a process generator 18 which is designed for the manual assigning respectively of a data set to a state parameter P1, P2, P3 of the plastic injection-moulding machine 1, and the process generator 18 is furthermore designed to automatically write into the data memory 17 the respective data set in accordance with the assigned state parameter P1, P2, P3, or to automatically read it out for display on the screen 12.1.

The process generator 18 is able to be operated in a programming mode for the manual assigning respectively of a data set to a state parameter P1, P2, P3 of the plastic injection-moulding machine 1, and is able to be operated in a process mode, in which the respective data set in accordance with the assigned state parameter P1, P2, P3 is automatically written into the data memory 17 or is automatically read out for display on the screen 12.1.

### LIST OF REFERENCE NUMBERS

1 plastic injection-moulding machine
2 machine frame
3 injection unit
4 closing unit
5 extruder
6 charging hopper
7 injection-moulding tool
7.1 one mould half
7.2 other mould half
8 closing unit
8.1 fixed platen
8.2 movable platen
9 cavity
10 machine controller
11 user interface device
12 output means
12.1 screen
13.1-13.4 input means
14 housing
15 camera
16 text information and/or image information
17 data memory
˜process generator
P1, P2, P3 state parameter

1.-9. (canceled)

10. A plastic injection-moulding machine, comprising:
an injection unit for processing a plastic mass to be moulded;
a closing unit including an injection-moulding tool having a cavity, into which the plastic mass processed by the injection unit is injected to produce a moulded part;
a machine controller configured to control operation of the injection unit and the closing unit in accordance with a machine program running on the machine controller, said machine controller including a data memory; and
a user interface device configured to communicate with the machine controller, said user interface device including a screen for displaying text information and/or image information stored in the data memory of the machine controller in the form of a plurality of data sets,
said machine controller including a process generator configured to manually assign each state parameter of the plastic injection-moulding machine a data set, and to automatically write the data set into the data memory, or to automatically read out the data set for display on the screen in accordance with the associated one of the state parameters, said process generator configured for operation in a programming mode for manual assigning a data set to a state parameter of the plastic injection-moulding machine, for operation in a process mode, in which the data set in accordance with the assigned state parameter is automatically written into the data memory or is automatically read out for display on the screen.

11. The plastic injection-moulding machine of claim 10, further comprising a camera configured to capture an image from a region of the plastic injection-moulding machine, said machine controller being configured to automatically record image information of the image and to deposit the image information in the data memory in accordance with a state parameter of the plastic injection-moulding machine

12. The plastic injection-moulding machine of claim 10, wherein the data memory is configured to store image information or further multimedia information, said machine controller being configured, in accordance with a state parameter of the plastic injection-moulding machine, to record, display, or deposit in the data memory the image information or the further multimedia information.

13. The plastic injection-moulding machine of claim 10, wherein the state parameter of the plastic injection-moulding machine is a program command in a sequence of several program commands of the machine program.

14. The plastic injection-moulding machine of claim 10, further comprising a sensor communicating with the machine controller and monitoring at least one process parameter of the plastic injection-moulding machine, wherein the state parameter of the plastic injection-moulding machine is a sensor signal provided by the sensor.

15. The plastic injection-moulding machine of claim 10, wherein the status parameter of the plastic injection-moulding machine is a control signal representing a malfunction at the plastic injection-moulding machine.

16. The plastic injection-moulding machine of claim 15, wherein the machine controller is configured to automatically display images, assigned to a respective malfunction type, in the form of individual images or in the form of image sequences or in the form of a video film on the screen of the user interface device, when the control signal conveyed to the machine controller contains an item of information characterizing the malfunction type.

17. The plastic injection-moulding machine of claim 10, wherein the machine controller is configured for manual inputting and for storing and outputting of indicated text information and/or image information at the plastic injection-moulding machine, with the image information stored in the data memory being assigned to a respective item of text information and/or image information.

18. The plastic injection-moulding machine of claim 10, wherein the user interface device has an input means, said machine controller being configured to record the images and to deposit them as image information in the data memory, when manually actuating the input means.
